(19) United States
(12) Patent Application Publication
(10) Pub. No.: US 2009/0109941 A1
(43) Pub. Date: Apr. 30, 2009

(54) WIRELESS ACCESS SYSTEMS

(75) Inventor: Mark Ian Carter, Reading (GB)

Correspondence Address: BAINWOOD HUANG & ASSOCIATES LLC, 2 CONNECTOR ROAD, WESTBOROUGH, MA, 01581, US

(73) Assignee: CONNECT SPOT LTD., Reading (GB)

(21) Appl. No.: 11/931,068

(22) Filed: Oct. 31, 2007

(51) Int. Cl. H04Q 7/24

(52) U.S. Cl. 370/338

(57) ABSTRACT

A method of providing access to a communications system via a plurality of wireless hotspot access points, comprising:
storing plural sets of user identification data relating to one or more wireless hotspot access points via which the user has authorization to access the communications system;
using a first set of user identification data to access the communications system via a first wireless hotspot access point; and
without user intervention, altering access to said communications system from being via said first hotspot access point to being via a second wireless hotspot access point, by:
identifying said second wireless hotspot access point; and
selecting, on the basis of said identification, a second set of user identification data, different to said first set of identification data, and
using said second set of user identification data to access the communication system via said second wireless hotspot access point.

### FIELD OF THE INVENTION

The present invention relates to wireless access systems, in particular but not exclusively systems for accessing a communications system including a network of wireless hotspot access points.

### BACKGROUND OF THE INVENTION

Currently users are required to remember a large number of credentials to gain access to various IT-based systems. This applies to wireless hotspot access points, which are controlled by different service providers—each service provider will typically provide their own set of credentials for user authentication. Furthermore, each wireless hotspot access point service provider's payments system is typically different

On the other hand, users require simplicity and would like to be able to seamlessly access the majority of service providers. Current systems require the user to remember each credential set for each different service provider's own system.

Wireless hotspot access point user credentials tend not to be meaningful, and difficult to remember, such as combined alphanumeric strings (which may be case sensitive) e.g. 7099znzkL55 and 2312a1cx66. Hence they are both difficult to remember and difficult to key in. These credentials tend to be presented as a username (or token) and a password.

Managing these large numbers of these credentials and presenting the correct username and password to the correct system can become very problematic for users.

Aggregators do supply credential sets that work across a wider footprint, however these normally require an annual contract commitment and are usually limited to the corporate market.

In the system described in US patent application US 2004/110530, a computer apparatus is capable of making radio or wireless communications via a predetermined access point. The computer apparatus comprises a connection candidate list for storing the identification information of known and hidden wireless access points. The system provides for the computer apparatus to retrieve by scanning an access point for connection and for the computer apparatus to be connected to a predetermined access point in an optimal time even when a network name of the access point is hidden. The connection setting information is associated with the network name and stored in the hard disk drive of the computer apparatus.

US patent application US 2004/106379 describes a method for automatic connection of a mobile station to a wireless LAN access point. The mobile station includes a measuring unit, a control unit having a map database and a communication unit having a setting table. The control unit determines an optimal wireless LAN access point based on the present GPS position of the mobile station measured by the measuring unit and based on the map database. The map database includes an identifier to identify each of a plurality of wireless LAN access point, connection setting data to communicate with each wireless LAN access point and position data for each wireless LAN access point. When the optimal wireless LAN access point is chosen, the connection setting data, including what is referred to as the identifier and the encryption, of the optimal wireless LAN access point is automatically set in the mobile station.

The system described in US patent application US 2004/198220 comprises a roaming wireless mobile device and a program executing on the wireless mobile device, the program being configured to cause the mobile device to use an association control list to control communication with access points and to update the association control list by communicating with the roaming server. The roaming server is configured to receive at least one access point identifier from a wireless mobile device and to transmit to the wireless mobile device information concerning at least one access point. The roaming server can also determine whether the wireless mobile device should communicate with the at least one access point by performing an authentication procedure using security information such as a name and password login.

US patent application US 2002/154607 relates to a network which includes a host device and a plurality of transceiver satellite nodes for communicating data from terminal devices interacting with the nodes, to the host. In order to initialize the network, the host's data store is loaded with data identifying each of the nodes. The host then pages the nodes using their identification data, and eventually a password. Although some nodes may be outside the range of the host, those that are within range will answer and establish communication with the host. Those nodes within range of the host then receive the list of identifications of all of the nodes, and store the list in their data stores. Those nodes then page the other nodes to find some of the nodes beyond the range of the host but within their own range. In successive iterations of the process, all nodes are found and linked into the network. All node-to-node paths are thus identified. A tag reader is connected to the host for reading tags associated with nodes and thereby capturing the identification codes of the nodes.

The problem with the systems described in the prior art is that they do not provide the ability for users to be able to roam between wireless hotspot access points which are controlled by different entities, including wireless hotspot access points controlled by service providers, corporate wireless hotspot access points and wireless hotspot access points controlled by private individuals.

A solution to this problem would be to set up network roaming arrangements between these various different entities. However, this requires, additional network infrastructure so as to interconnect the networks of different entities. To do this on a wide scale basis would be highly complex and costly.

It is an object of the invention to provide improved systems for providing the ability to be able to roam between wireless hotspot access points which are controlled by different entities.

### SUMMARY OF THE INVENTION

In accordance with one aspect of the present invention there is provided a method of providing a user with access to a communications system via a plurality of wireless hotspot access points, said method comprising providing a set of functions for use on a user terminal, said functions including functions for:

storing a plurality of sets of user identification data, said user identification data relating to one or more wireless hotspot access points via which the user has authorization to access the communications system;

using a first set of said plurality of sets of user identification data to access the communications system via a first wireless hotspot access point; and

without user intervention, altering access to said communications system from being via said first hotspot access point to being via a second wireless hotspot access point, by:

identifying said second wireless hotspot access point; and

selecting, on the basis of said identification, a second set of user identification data, different to said first set of identification data, and

using said second set of user identification data to access the communication system via said second wireless hotspot access point.

This aspect of the invention thus provides a user terminal-based network access function to enable users to roam between wireless hotspot access points which are controlled by different service providers, without requiring a user to manually set up each communications session with a series of different hotspot access points controlled by different service providers, which is highly inconvenient if the user is mobile such that coverage is lost from a hotspot access point on a regular basis. It increases the range of hotspot access points available to such a mobile user—all service providers provide coverage in different locations—without making it necessary for the user to keep track of all appropriate user identifications for the different service providers.

According to a further aspect of the invention, there is provided a method of providing a user with access to a communications system via a plurality of wireless hotspot access points, said method comprising providing a set of functions for use on a user terminal, said functions including functions for:

using first user identification data to access the communications system via a first wireless hotspot access point; and

altering access to said communications system from being via said first hotspot access point to being via a second wireless hotspot access point, by:
identifying said second wireless hotspot access point; and
in response to said identification, using second user identification data, different to said first user identification data, to access the communication system via said second wireless hotspot access point;

selecting access settings, said access settings including settings for determining whether altering access to said communications system from being via said first hotspot access point to being via a second wireless hotspot access point is conducted either:
a) without user intervention; or
b) after receiving user input confirming a user's decision to proceed.

This aspect of the invention aims to provide two mode settings for use in accessing any of a plurality of wireless hotspot access points in different networks.

This aspect enables users to roam, and to control the manner of the roaming, between wireless hotspot access points which are controlled by different service providers.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a diagram giving an overview of the system of the invention;

FIG. 2 is a flow diagram illustrating a registration and credentials choice procedure;

FIG. 3 shows a user interface of the application, whereby user profile settings are made;

FIG. 4 shows a user interface showing the contents of a credentials wallet;

FIG. 5 shows a user interface for adding or editing user credentials manually to the credentials wallet;

FIG. 6 is a flow chart showing a search and login procedure carried out by the network access application on the user terminal;

FIG. 7 shows the user interface of the network access application of the invention, whereby a search for a wireless hotspot access point is initiated;

FIG. 8 shows a set of search results provided by the network access application;

FIG. 9 shows a user interface for logging into a site using credentials stored in the credentials wallet;

FIG. 10 shows a further set of search results provided by the network access application;

FIG. 11 is a flow diagram showing an update procedure carried out by the network access application on the user terminal;

FIG. 12 is a flow diagram illustrating a session control procedure carried out by the network access application on the user terminal.

FIG. 13 is a flow diagram illustrating an access control procedure carried out by the network access application on the user terminal when in “always on” mode.

FIG. 14 is a flow chart showing an automatic hotspot access point search procedure carried out by the network access application on the user terminal.

### DETAILED DESCRIPTION OF THE INVENTION

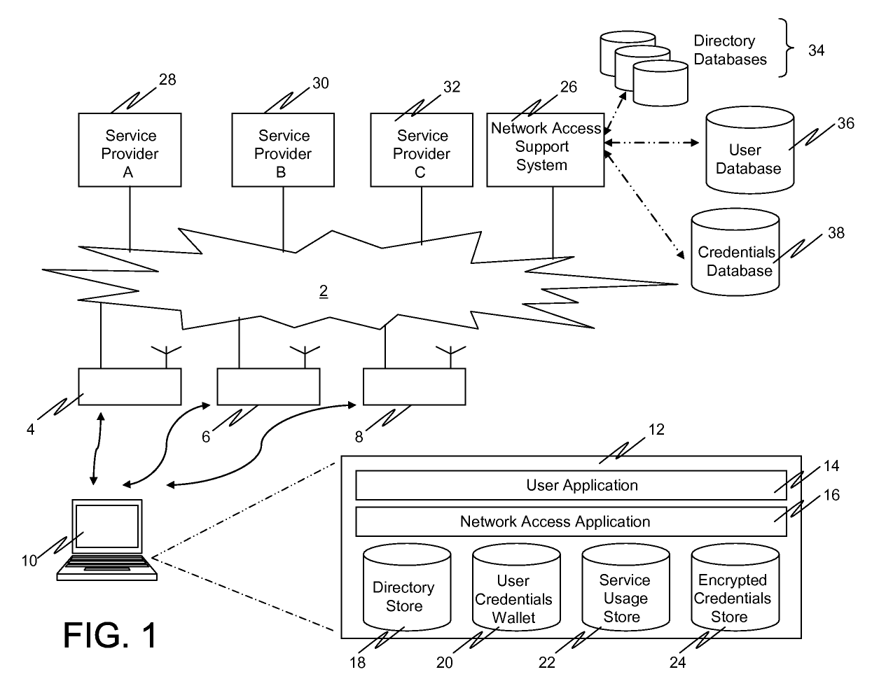

FIG. 1 shows an overview of the system of the invention, in which a communications network 2, which in this embodiment is the Internet, is accessed via a plurality of wireless access points 4, 6, 8. Each of these wireless access points implements a radio interface whereby access to the communications network 2 can be given to user terminals communicating with the wireless access point via a radio communications protocol.

In this embodiment of the invention, the wireless access points 4, 6, 8, implement an IEEE 802.11 wireless communications standard (examples include variants of the 802.11 standard such as IEEE 802.11a, IEEE 802.11b, IEEE 802.11g). The 802.11 standards are commonly referred as WiFi™, which is a trademark of the Wifi Alliance.

One or more of the wireless hotspot access points may implement an IEEE 802.16 wireless communication standard (examples include variants of the 802.16 standard such as IEEE 802.16a, IEEE 802.16b, IEEE 802.16 g). The 802.16 standards are commonly referred by the term WiMax™, which is a trademark of the WiMax Forum.

Wi-Fi and WiMax hotspot access points will collectively be referred to herein using the term “wireless hotspot access points”. Wireless hotspot access points require an authentication procedure to be conducted every time the user moves to a different wireless hotspot access point, i.e. to gain access to the communications system via a different wireless hotspot access point.

Other wireless access nodes (not shown) included within the system, and with which the present invention may also be utilised, implement a cellular radio communications standard, including a 2G standard such as GSM and a 3G standard such as UMTS. These are referred to collectively herein as “cellular radio access nodes” and it should be understood these are not “hotspot access points”, since they do not require an authentication procedure to be conducted every time the user moves to a different radio access node as the access session can be handed over from one such node to another without requiring re-authentication of the user terminal.

FIG. 1 shows a user terminal 10 located in the coverage region each of the three illustrated hotspot access points 4, 6, 8. The user terminal 10 may be a portable computer, such as a laptop computer; a personal digital assistant (PDA); a smart phone; or a similar device, and includes a data storage device 12, such as a hard drive, on which various different software applications are stored along with user data. The software applications include a set of one or more user applications requiring network access, such as a web browser, an email client application and a Voice-over-IP (VoIP) telephony application. Of these a representative single user application 14 is shown and referred to below, however it should be understood that one or more of these may be present and operated in the manner described. The software applications also include a network access application 16 according to the present invention. The network access application 16 controls network access so as to provide the user application 14 with network connectivity.

Associated with the network access application 16 is a directory store 18, which includes geographical location data and identification data for a large number of geographically dispersed wireless hotspot access points and a user credentials store or “wallet” 20. The wallet stores a plurality of sets of user credentials, each associated with a different network access right which the user is entitled to. The user credentials are for presentation to a service provider to authenticate the user, thereby to allow the user to gain network access rights associated with the credentials. The user credentials may also, or alternatively include user identification data in the form of a security key, such as a Wired Equivalent Privacy (WEP) key.

Such network access rights may be in the form of a type of rights referred to as a “voucher”, which is a set of credentials which is typically purchased and which entitles the user to a certain limited amount of network access. Typically, the credentials will be in the form of limited validity user credentials, referred to as a “voucher”. Such vouchers can be purchased in a variety of ways, including on-line vouchers and physical tokens such as scratch-off cards. Purchasing a voucher will typically provide the user with a username and password which are of limited validity. Once the voucher is used up, the credentials are no longer valid and can be discarded.

Other types of access rights which are authenticated using credentials include subscription rights, whereby a user has a long term relationship with a service provider, and the subscription credentials are used to authenticate the user. Such a subscription will typically involve a billing relationship, whereby the user is occasionally billed for the network usage which the user obtains via the subscription.

A service provider will typically require a login using credentials and monitor the usage session and keep a record of amounts of usage monitored during the user's sessions. If the usage monitored exceeds a pre-set threshold, the service provider may terminate the session and prevent login using the same credentials. Alternatively, the access rights may provide for unlimited usage during a given period of validity associated with the credentials. Once the period of validity ends, the service provider may terminate the session and prevent login using the same credentials.

Also associated with the network access application 16 is a service usage store 22 and 24. The network access application 16 interworks with a network access support system 26, and sets up a communications session with the network access support system 26 during a network access session, through which updates can be sent between the network access application 16 and the network access support system 26.

Associated with the network access support system 26 is a set of directory databases 34 and a set of user databases which store user specific data, i.e. a user database 36 which stores credentials sales records and a credentials database 38.

Each wireless hotspot access point 4, 6, 8 may be either private, and accessible only to users associated specifically with the wireless hotspot access point, such as the wireless hotspot access points of a corporate wireless local area network (WLAN). However, there are also many service providers which provide public access wireless hotspot access points. These public access wireless hotspot access points can be, in some cases, freely available. In the majority of cases, the wireless hotspot access points are publicly available, conditioned upon users purchasing access. In order to prevent users who have not purchased access from using the facilities provided by the public access wireless hotspot access points, the wireless hotspot access points are protected by means of an authentication procedure. The procedure is for authenticating authorized users who have purchased the right to network access via the wireless hotspot access points belonging to the service provider in question. A single service provider may own, and therefore control access to, a large number of wireless hotspot access points which are geographically dispersed. The authentication may be web-based and/or authentication client-based. Typically, the wireless hotspot access points will include a web server application for transmitting a login web page to a user terminal attempting to gain network access via the wireless hotspot access point. The web page will include a number of form fields for entering a set of credentials, typically username and password, which the user must fill in and transmit back to the wireless hotspot access point. The wireless hotspot access point may also provide for automated login using an authentication client provided on the user terminal. In this case, the wireless hotspot access point implements a wireless hotspot access point authentication protocol such as GIS (a proprietary protocol used by the company IPASS) or the WISPr protocol (an IETF standard). In both cases, the user credentials are passed over to the wireless hotspot access point for authentication.

The service provider systems 28, 30, 32 may include a remote authentication server, typically a RADIUS or AAA server, for performing authentication. The wireless hotspot access point transmits the received credentials to the authentication server, and if authentication is successful, permits the user network access, typically for web browsing, email download, etc, but many other data communications types are also performed in this way, including Voice Over Internet Protocol (VOIP) telephone calls, using the user application 14. Once authenticated, the user's session is monitored, and if the validity of the credentials used expires, the user's session is terminated and the user's web browser application is redirected to the login web page.

Typically, in high density areas, a user will have a choice of public access wireless hotspot access points, and this situation is illustrated as an example in FIG. 1. In other areas, a user will have no available public access wireless hotspot access point, and will use the network access application to identify a proximate wireless hotspot access point for which the user has, or can purchase, credentials. If no such proximate wireless hotspot access point exists, network access may be provided via network access provided by alternate means which are within the user terminal's capabilities. For example, a smart phone may include a built-in cellular radio interface whereby such alternate network access may be provided. A laptop may include a cellular radio interface card to provide such alternate network access.

Each of the wireless hotspot access points 4, 6, 8 illustrated in FIG. 1 is a public access wireless hotspot access point. Each is controlled by a different service provider. In this example, wireless hotspot access point 4 is controlled by service provider A 28, wireless hotspot access point 6 is controlled by service provider B 30 and wireless hotspot access point 8 is controlled by service provider C 32. The network access application 16 includes directory information for the wireless hotspot access points, including geographical location data for identifying the location of the wireless hotspot access point, but also identification data for identifying the wireless hotspot access points from either a Service Set Identifier (SSID), which is unique to a service provider which may control a large number of wireless hotspot access points, or a Media Access Control (MAC) address, which is unique to a wireless hotspot access point. Each wireless hotspot access point broadcasts both its SSID and MAC address.

The directory store 18 associated with the network access application 16 includes, where known, the MAC address of each wireless hotspot access point. Thus, a wireless hotspot access point can be identified by means of the MAC address alone, if the user is within the coverage of the wireless hotspot access point. If the directory store 18 associated to the network access application 16 does not currently hold a MAC address for a public access wireless hotspot access point which nevertheless includes an entry within the directory, it can be identified by means of the SSID and/or the geographical data held within the network access application for the wireless hotspot access point. For example, an SSID-based search can be used to find all wireless hotspot access points belonging to a given service provider. The search can be further limited by geographical parameters, such as geographical location coordinates, a geographical location name and/or postcode data (for example a postcode prefix.) Even if the network access application does not currently hold an entry for the wireless hotspot access point, the identity of the service provider can be determined by means of the SSID received from the wireless hotspot access point. In any of these ways, a set of search results can be provided which identifies a set of one or more wireless hotspot access points. Then, on a user interface, the user can be shown, via a directory search results screen, all of the wireless hotspot access points in the directory which fall within the search parameters specified.

The user credentials wallet 20 identifies each voucher by means of an SSID of the service provider, and then network access application 16 can match this to the SSID of the wireless hotspot access point to determine whether the user has authorization to receive network access via the wireless hotspot access point. The wallet includes a table showing information relating to a set of credentials including service provider, voucher type, duration, first login, valid until, issued date, expiry date. Typically, the user will have credentials valid only for some of the public access wireless hotspot access points, and therefore the choice of the user are more limited than the full set of public access wireless hotspot access points covering the user's location. The network access application 16 then preferably indicates in a search result screen, either individual results or a combined result screen, whether the user currently has authorization to receive network access via the wireless hotspot access point in question. An indication that the user is authorized is preferably given in a form associated with an automated login function, which is activated, causes the application to perform a login, either via an auto-fill of the login web page form with the credentials, or by using an authentication client such as a WISPr client. The indication is preferably a login button on the search results screen.

The user credential wallet stores two types of user credentials in a user terminal 10. These include:
i) first user credentials which are held in a first state, and in said first state, the user can use the credentials to access the communications system via an identified wireless hotspot access point; and
ii) second user credentials which are held in a second state, and in said second state, the user cannot use the credentials to access the communications system via an identified wireless hotspot access point; and

conducting a procedure whereby said second user credentials are converted to said first state.

This allows the application to preload sets of credentials into a hidden area in the second state. The user credentials when in the second state are in a preferred embodiment encrypted and, if such user credentials are stored for a wireless hotspot access point identified in a set of search results, the network access application then preferably indicates in a search result screen, either individual results or a combined result screen, whether the user currently has stored in their credentials wallet encrypted credentials which can be unencrypted using a purchase procedure thereby to give the user authorization to receive network access via the wireless hotspot access point in question. An indication that such encrypted credentials are held is preferably given in a form associated with an automated purchase function, which when activated, causes the application to decrypt the credentials and place the credentials in the list of credentials which the user can use to receive network access. A sales record is generated and sent by the network access application 16 to the network access support system 26 for billing purposes.

If the user has credentials for only one of the service providers, the choice of credentials is straightforward. However, if the user has more than one set of credentials which may be used, the network access application 16 will use preference data associated with each of the sets of credentials to determine which one to use in preference to the other. This preference data will typically be related to the cost of access, and the network access application 16 will select a set of credentials use according to which provides the lowest cost of access available.

The user credentials are typically of limited validity and have one or more predetermined usage limits associated therewith in the communications system. The network access application 16 and/or the network access support system 26 are capable of monitoring usage of the limited validity user credentials, and in response to an event may conduct a transfer of limited validity user credentials between the user terminal and the network access support system 26. New credentials can be sent from the network access support system 26, either for immediate placing in the unencrypted user credentials list or for storage as encrypted user credentials which may be later activated. Partly used credentials can also be transmitted back to the network access support system 26 for re-use by another user.

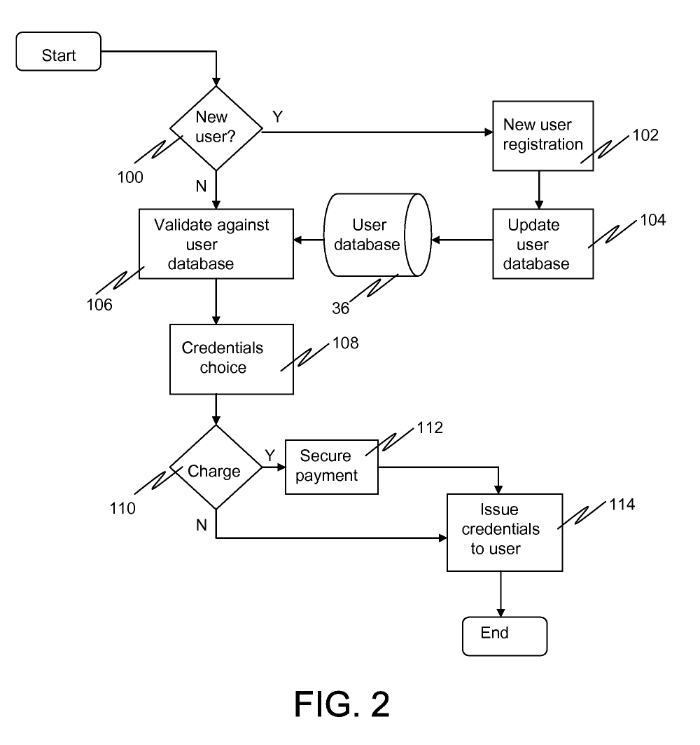

Further understanding of the invention will be gained from consideration of accompanying FIGS. 2 to 12, which provide further details relating to the above-described functionality.

FIG. 2 is a flow diagram illustrating a registration procedure carried out by the network access support system 26 when contacted by a network access application 16 in relation to a request for new credentials to be issued to the user, after the user has downloaded or otherwise supplied a copy of the network access application to their user terminal and installed the application. Each network access application is provided with its own unique identity and licence key, whereby the network access support system 26 initially identifies the network access application 16 when the network access application 16 transmits data to the network access support system 26 via the network 2. At step 100, the network access support 26 determines whether a user has been registered to use the network access application 16.

If the user has not previously registered, the network access support system 26 conducts a new user registration procedure 102, during which the user provides personal data via a personal data entry interface on the network access application 16, and, on receipt of the personal data, updates the user database 36 in step 104. Once the user has registered, the user can be validated against the user database 106. During the registration procedure, the user provides a user name and password for validation purposes, which are stored in the user database 36 and validated when the user subsequently requires validation.

After validation in step 106, the user selects a credentials type choice 108. The user is provided with a choice of one or more different voucher types, each with a different set of usage parameters, and/or one or more different subscription types. When the credentials choice has been made, the network access support system 26 determines whether a charge is required, step 110. If a charge is required, the user is led through a secure payment procedure 112, such as an on-line credit card charging procedure. If no charge is required, or if the secure payment procedure 112 is completed, the user is issued with the credentials, step 114. Issuing the user with credentials involves retrieving one or more sets of credentials from the credentials database 38 and transmitting these, during an update procedure, to the network access application 16 for storage in the user credentials wallet 20.

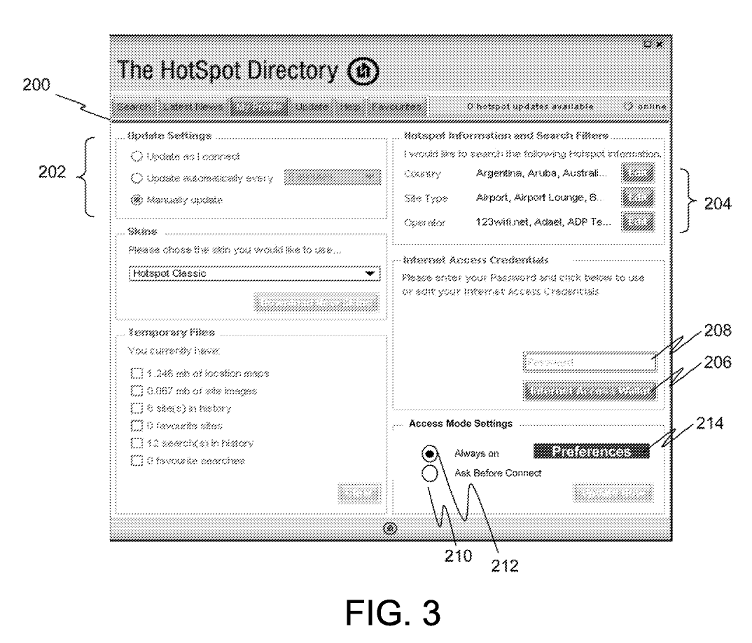

FIG. 3 shows a user interface of the network access application 16, whereby user profile settings are made within the application. The user interface is in the form of a display 200 shown on the screen of the user terminal 10, containing selectable items and links to further parts of the application. The profile screen 200 includes a set of update settings 202, including “update as I connect”, which ensures that the network access application 16 checks for updates from the network access support system 26 immediately when the application goes on line, “update automatically every [x] minutes”, which ensures that a regular check is made at a regular interval, and “update manually”, which allows the user to determine when the application checks for updates, and in which case the user initiates an update procedure manually. The profile screen 200 also includes a set of “hotspot information and search filters” settings 204. These settings determine the extent and type of information stored in the directory store 18. The filters include a “country” filter, allowing the user to select a limited set of countries for which wireless hotspot access point directory information is to be stored in directory store 18, “site type” which allows the user to select a particular type of wireless hotspot access point location, and “operator” which allows the user to select a limited set of services providers for which wireless hotspot access point directory information is stored. In this way, the network access application can be customised to ensure that the directory store 18 only stores information which is of use and potential interest to the user.

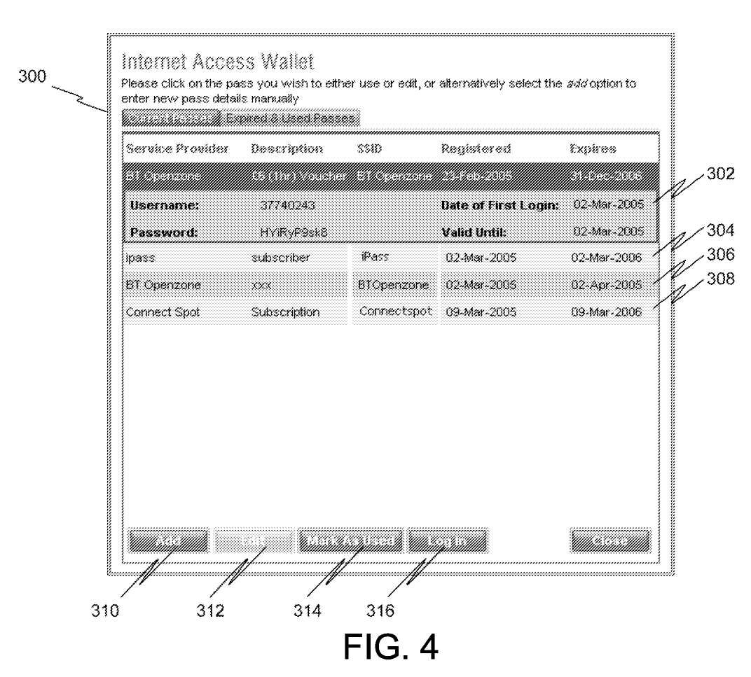

The profile screen 200 also includes a section in which the user credentials wallet can be accessed, via the “internet access wallet” link 206. If the user actuates this link, a password entry box 208 appears for entry of a password protecting the contents of the wallet. On entry of the correct password, an internet access wallet screen 300, as shown in FIG. 4, is displayed.

The profile screen also includes a section in which the user can select one of two access settings, a user entry part 210 for selecting an “always on” mode and a user entry part 212 for selecting an “ask before connect” mode. These will be described in further detail below. Associated with the “always on” mode is a “preferences” user entry part 214 which, when actuated brings up a screen (not shown) for entering user preference settings to set features controlling the operation of the network access application 16 when in an “always on” mode. In this embodiment these “always on” mode preference settings include:

a) select lowest cost

b) select highest signal strength

c) select hotspot access point capability where available (e.g. virtual private network (VPN) capability)

d) select cellular radio access if available signal strength is lower than a predetermined threshold

e) select highest speed backhaul

f) select a voice only hotspot access point These may be simple on-off preference settings or each setting may be provided with a variable preference value (for example by means of a value entry box on a scale of 1 to 100). If on-off preference settings are provided, some may be mutually exclusive (e.g. select lowest cost and select highest signal strength are mutually exclusive settings). If a variable preference value is provided for, a weighting can be provided during operation of the “always on” mode according to the importance attributed to the associated setting. The operation of the “always on” mode associated with these user preference settings will be described in further detail below.

Referring to FIG. 4, the internet access wallet screen 300 shows all of the sets of credentials currently held for the user in a list format. In this example, four sets of credentials 302, 304, 306, 308 are currently held. A user is able to select any of the items in the list to show more detailed information. Before an item is selected, the list shows the name of the service provider, a description of the type of rights which the credentials are associated with (for example a subscription, a limited validity set of credentials such as a one hour voucher, etc.), the SSID used by the service provider in each of its wireless hotspot access points (which is often the same as the name of the service provider), the date when the set of credentials was first entered in the wallet, and the expiry date of the set of credentials.

On selection of an item in the list, further details are displayed, as is shown in this example for the set of credentials 302. These further details include the actual credentials themselves, in this case a user name and password which are each in the form of an alphanumeric string, the date of first login and a “valid until” date. Note that the expiry date and the “valid until” date for a set of vouchers may be quite different. The expiry date is set before the set of credentials are first used, whereas if a set of credentials has a limited validity based upon its first usage date, the valid until date will be set based upon the date of first usage. For example, if a set of credentials has a one month validity period based upon the first usage, the valid until date will be set at one month beyond the initial usage date of the set of credentials.

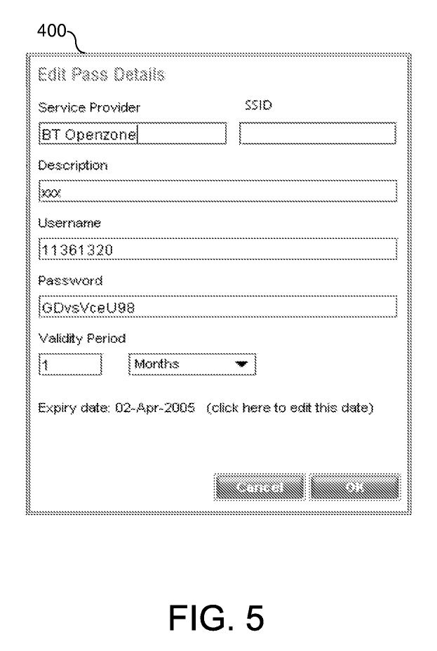

Also shown in the internet access wallet screen 300 is a set of links 310, 312, 314 and 316 allowing the user to perform functions in relation to the sets of credentials stored. A first link 310 allows a user to add a new set of credentials. A further link 312 allows the user to edit the credentials details. The editing of credentials details screen which the link 312 links through to is shown in FIG. 5, and is very similar to the adding of credentials details screen.

As shown in FIG. 5, the edit credentials details screen 400 allows the user to manually enter and edit details for a set of credentials, including the identity of the service provider, a description for the set of credentials, the credentials themselves, in this case a user name and password combination, a validity period for the set of credentials, and an expiry date. Therefore, the user can purchase a set of credentials via any of a number of different existing ways in which credentials may be bought. For example, a set of credentials may be purchased by means of scratch-off card. The user can then manually add the details for the credentials into the network access application via this interface so that the credentials and the associated details are stored in the user credentials wallet 20 for subsequent usage via the network access application 16.

Referring back to FIG. 4, a further link 314 allows the user to mark a selected set of credentials as having been used, in which case the set of credentials is removed from the list shown. A further link 316 allows the user to login to a wireless hotspot access point using the set of credentials. On selecting the login button 316, the network access application determines whether a suitable wireless hotspot access point can be used in the current location, as will be described in further detail below, using the credentials which are currently selected when the user actuates the login button 316.

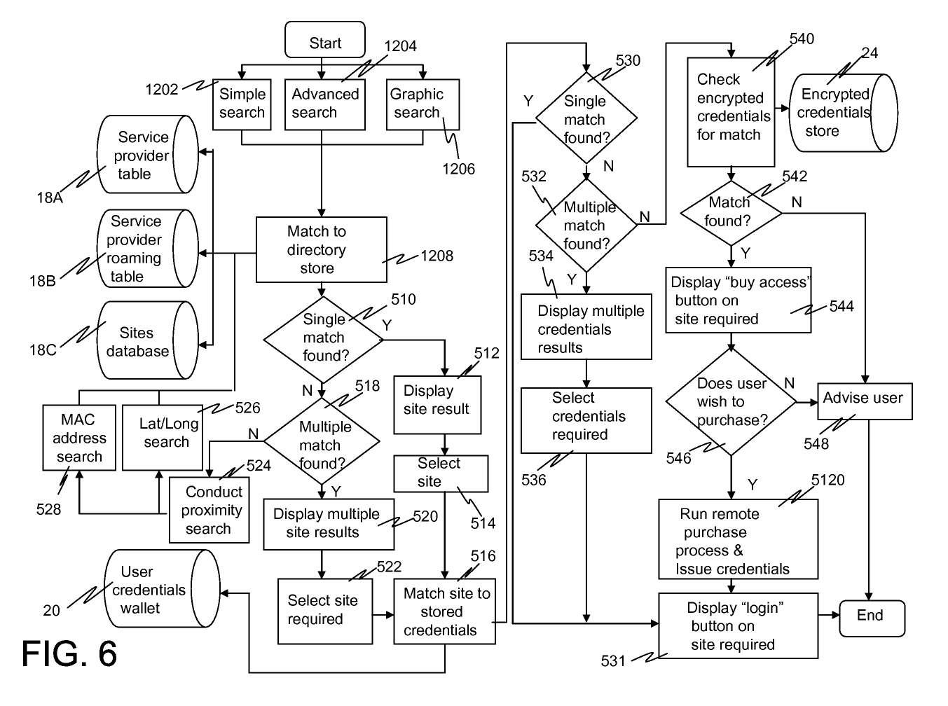

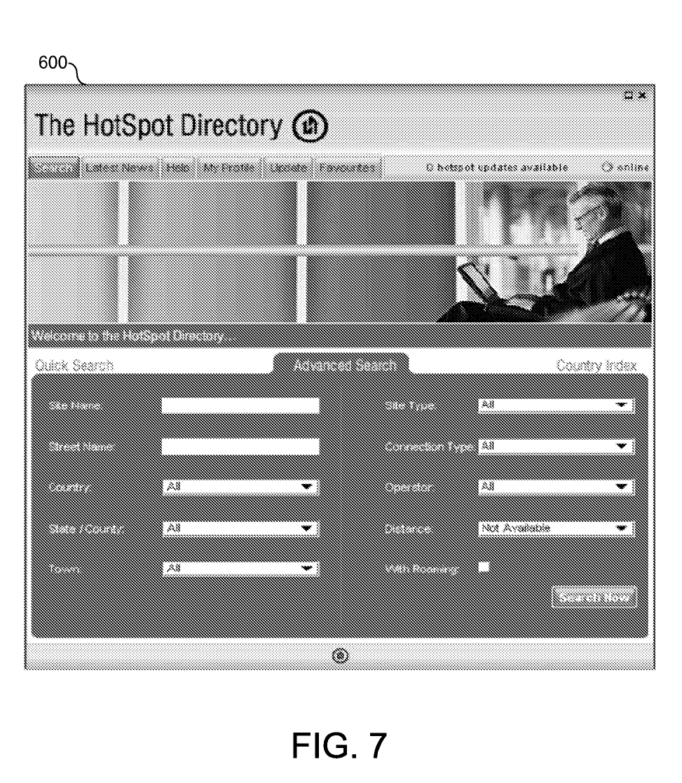

FIG. 6 illustrates procedures carried out by the network access application 16 when “ask before connect” access mode is selected. These include procedures for, firstly, finding a wireless hotspot access point, referred herein also as a “site”, from the directory store 18 which matches search criteria specified by the user, secondly to identify whether credentials are stored for any of the found sites, and thirdly, to allow the user to have access to encrypted credentials, if the user has no credentials currently available for use in their user credentials wallet 20. The search procedure may be initiated by any of three different types of search. The user may conduct a text search 502 a parameter search 504 or a graphic search 506. The text and parameter based searches 502, 504 are accessed by a user interface similar to that shown in FIG. 7, namely a search input screen 600. The search input screen allows the user to enter text, such as a site name a street name etc., which is used to match against site entries in the directory store 18. The directory store 18 includes a site database 18C which contains information including site names, address, type of site, connection type, geographical location (including latitude and longitude coordinates), SSID and MAC address for the site. The directory store 18 also includes a service provider table which provides service provider details related to the sites in sites database 18C, and a service provider roaming table 18B which indicates roaming partnerships between service providers. Therefore, the service provider tables 18A and 18B together indicate, for a particular site, which service provider the site belongs to, and which roaming partners have agreements with the service provider to allow the credentials of one service provider be used to access network resources via a site provided by a different service provider. A graphic search 506 is conducted using a map-based interface (not shown), whereby a user can click on a map to search for relevant sites within a specific geographic area.

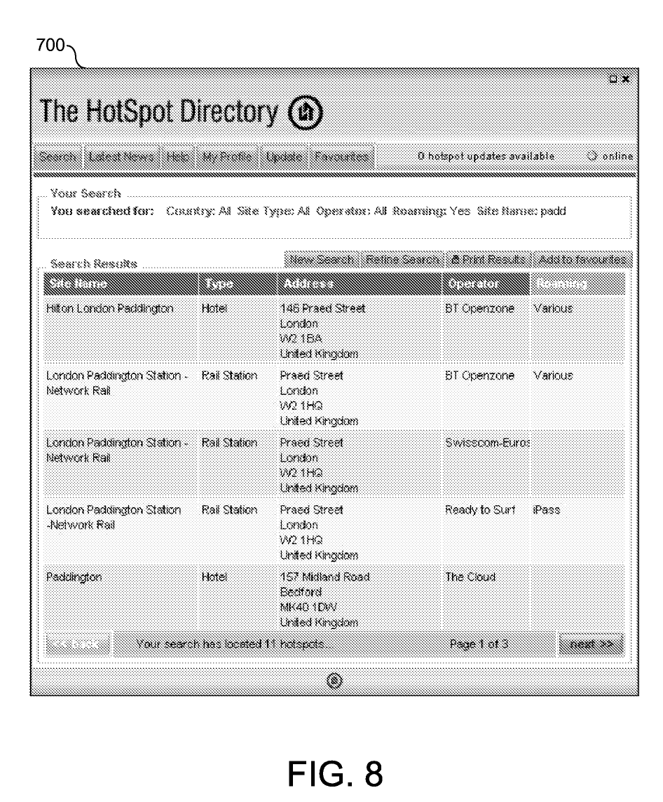

Whichever manner of search is used, the application then matches the search criteria to sites listed in the directory store 508. If only a single site is found which matches the search criteria in step 510, the results are shown in a results screen. An exemplary results screen 700 is shown in FIG. 8. The network access application 16 then selects the site 514 and attempts to match the site to credentials stored in the users credential wallet 20, as will be described in further detail below. If in step 510, a multiple set of sites is found, the multiple site results are shown in the search results screen 700 similar to the example shown in FIG. 8, step 520, and the user is then prompted to select one of the sites, leading to step 516 and onwards as will be described further below. If no results are identified using the search criteria, the user has the option to conduct a proximity-based search 524. Note that, alternatively, the network access application 16 may automatically conduct a proximity search without requiring user initiation.

When a proximity-based search is carried out in step 524, the network access application 16 searches the directory store 18 using parameters which may not necessarily be entered by the user. For example, the parameters may be a set of geographical coordinates derived from a positioning system, for example a global positioning system (GPS) receiver. This identifies a particular geographical location whereby the sites database 18C may be queried, and further matches may be found. Alternatively, the proximity search may be based on an automatically detected MAC address, step 528. In step 528, the network access application uses a “sniffer” program to detect the MAC address of a wireless hotspot access point which the user terminal currently is receiving a signal for. By detecting the MAC address, this MAC address can then be used as an entry point into the sites database 18C. Namely, if the MAC address detected over the air matches the MAC address of an entry in the database store 18, this can be used to identify the current location of the terminal, which in turn can be used a search criteria in order to determine further sites in the proximity of the terminal. Note that these further sites may not necessarily currently be within signal range of the terminal. However, the user can move to within the signal range of the site once the location of the site has been identified via the directory store.

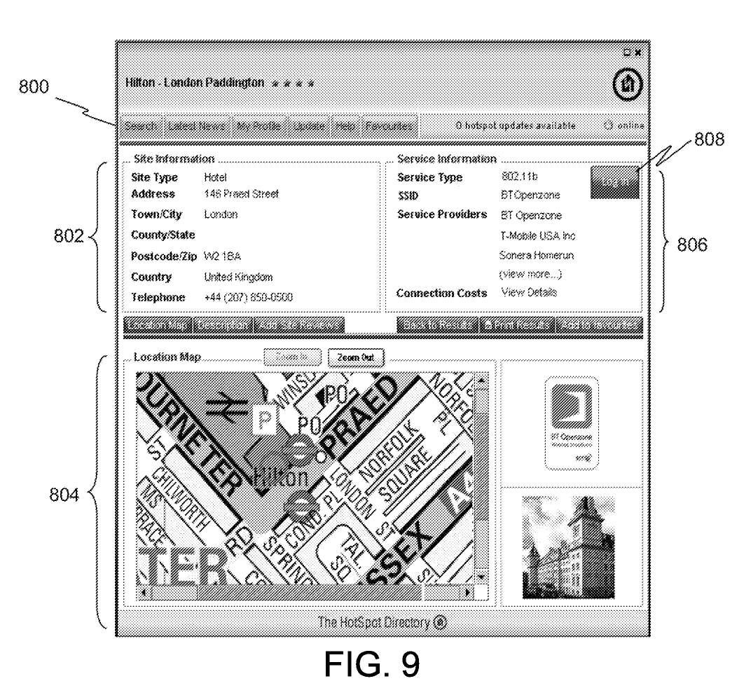

Once a user has selected a site from the search results screen 700, the network access application 16 attempts to match the site to credentials stored in the user credentials wallet 20. When the user selects one of the search results, a site display screen 800 is provided, as shown in FIG. 9.

The site display screen 800 includes site information 802, showing information such as the site type, the address of the site, and contact information for the site, such as the telephone number. The site display screen 800 also includes a map 804 showing the location of the site on a street map. Further information which may be provided includes a description of the site, and a set of site reviews provided by users. A site review can be added by the user to the body of site reviews via their network access application, and the site review is then uploaded to the network access support system 26 for subsequent distribution to all users having interest in that site. Also included in the site display screen 800 is a service information section 806. In the service information section 806, the type of service and the name or SSID of the service provider are shown. Also, a list of names or SSIDs of roaming partners, determined from service provider roaming table 18B, is shown as a set of service providers which provide access to the site. Furthermore, if the user has access to the site due to an appropriate set of credentials being stored in the credentials wallet 20, the network access application provides a “login” button 808 to indicate that the user can login to the site providing they are within the coverage area of the site.

Reverting to FIG. 6, in order to determine whether to present the “login” button 808 on the site display screen 800, the network access application attempts to match the site service information to the credentials stored in the user credentials wallet 20. Namely, the network access application 16 searches the user credentials wallet for credentials having a SSID which matches either the SSID of the service provider roaming site, or the SSID of each of the roaming partners of the service provider owning the site, as determined from service provider table 18A and service provider roaming table 18B. If the appropriate credentials are found, the “login” button 808 is displayed.

FIG. 6 illustrates in further detail processes carried out by the network access application 16 during this procedure. If a single match is found 530, a “login” button is provided, step 531, allowing the user to login immediately. If multiple matches are found in step 532, multiple credentials are shown and a set of credentials are selected before the user can login, step 536. Selection between credentials may be conducted by the user themselves, namely by selecting the credentials that they wish to use to login according to their own preferences, or may be conducted automatically. Namely, the network access application 16 may conduct some form of comparison between the cost parameters and/or user preferences previously set for the various sets of credentials, and determine a preferred selection according to the comparison. If in 532 no match is found, this indicates that the user does not currently have authorization to access the site. However, it is possible that an appropriate encoded set of credentials is stored in the encrypted credentials store 24. The application checks in step 540 whether the user credentials store 24 has an appropriate match. If no appropriate match is found, the user is advised, for example by the absence of a login button, that no credentials are currently stored or available in the application itself. The user can then use a web-based credentials purchasing procedure or use another credentials purchasing option (such as buying a scratch card) in order to gain authorization to access the site. These new credentials may then be added to the credentials wallet 20 using the “add credentials” option as described above.

If a match is found in step 542 a “buy access” button is shown instead of the “login” button 808 on the site display screen 800. When the user actuates the “buy access” button, the user is presented with a cost and other details for the credentials offered, and it is determined whether the user wishes to purchase the credentials stored in the encrypted credentials store 24. If the user does not wish to purchase, the user is advised 548 and the procedure ends. If the user does wish to purchase the credentials in step 546, a “remote purchase” process is carried out whereby the network access application 16 decrypts the appropriate set of encrypted credentials, and transfers the credentials to the user credentials wallet 20. At the same time, a sales record is generated by the network access application 16 which is stored in the service usage store 22. The sales record is then subsequently transferred back to the network access provider system 26 once the user is on-line, during an update procedure as described in further detail below. Once purchased, the appropriate credentials are indeed held by the user in the user credentials wallet 20, and the “login” button 808 is displayed for immediate usage is the user wishes to gain access by the site.

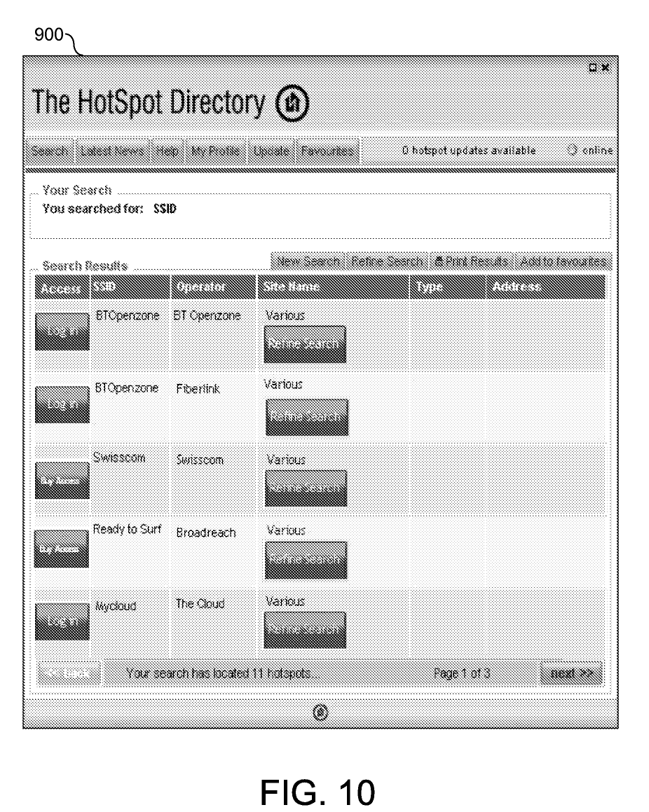

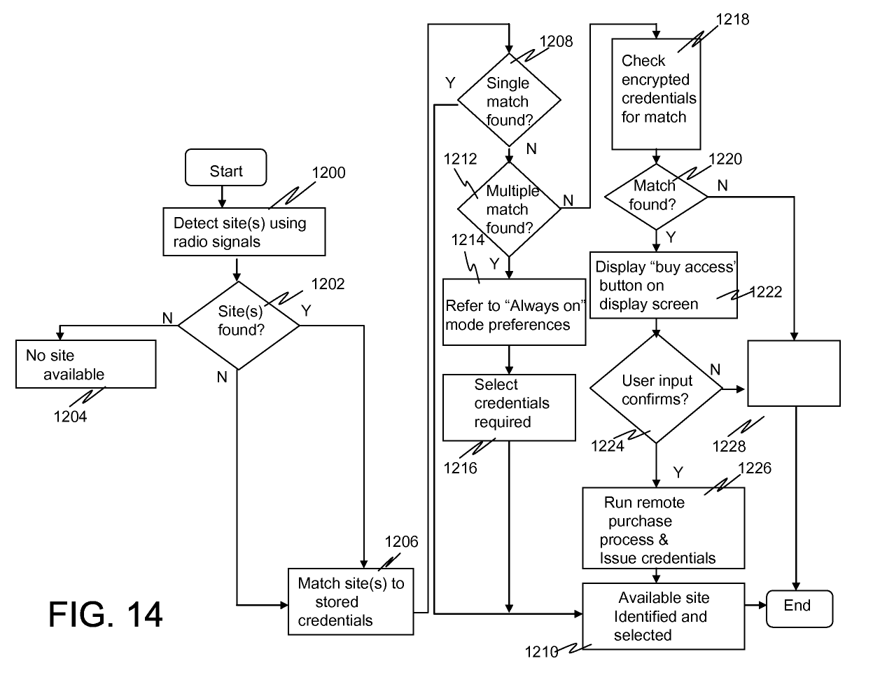

FIG. 10 illustrates the results of a further search type, similar to that illustrated in FIG. 14 below (including all steps up to stage 212 in the procedure). FIG. 14 describes steps taken in the “always on” access mode is selected but is also possible when the user has selected the “ask before connect” access mode. In this type of search, the network access application 16 uses a “sniffer” application in the terminal 10 to find all wireless hotspot access points for which a signal is currently available. In this type of search, the network access application 16 detects from the signals received from each wireless hotspot access point the SSID of the operator, and presents each of the found sites in a search result screen 900. Note that none of these search results rely on data stored within the directory store 18, other than the service provider table 18A which links the SSID to the name of the operator. By searching for SSID only, no site is currently individually identified, and the site name is shown as “various”. By selecting a “refine search” option, the user can identify the search by use of appropriate search parameters, if desired. Furthermore, the network access application 16 conducts the procedure shown in the right hand side of FIG. 6, namely steps 516 onwards, in order to determine whether to display a “login” button next to each of the identified sites, or a “buy access” button next to an identified site, or whether to display no access possibilities adjacent each site. By selecting a “login” button, the user is able to achieve network access via the selected site and by using a “buy access” button the user is able to retrieve and decrypt an appropriate set of credentials from the encrypted credentials store 24 for logging into the identified site.

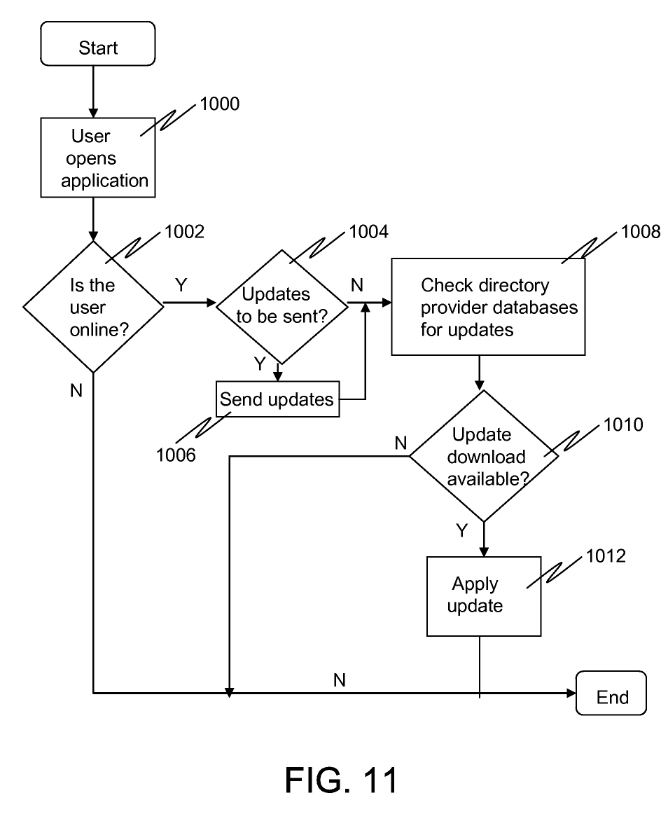

FIG. 11 illustrates a procedure carried out by the network access application 16 in order to transmit updates to the network access support system 26 and receive updates from the network access support system. The procedure begins when the user opens the application 1000 and checks whether the user is on-line 1002. If the user is not on-line, the updates cannot occur and the procedure ends. If the user is currently on-line, the network access application 16 checks whether updates are to be sent 1004, in which case it sends an update to the network access support system 26. Updates are for example sent when a new service record is stored in service usage store 22.

Next, the application 16 checks whether any updates are stored in the user database 26, in step 1008. If available, step 1010, the update is downloaded and applied. The updates may take the form of new user credentials which are to be stored directly in user credentials wallet 20. Such new user credentials may be made available as an update if, for example, the user has conducted a purchase of credentials via a website associated with the network access support system 26. By conducting a purchase of credentials via a website associated with the network access support system 26, the credentials may be transmitted to the network access support system 26 after purchase, so that they can then be automatically downloaded to the users credentials wallet 20 when the user next gets on-line. Another type of updates which may be applied include updates to the directory store 18, if any new site details which match the users site details settings are made available in the directory database 34.

Another type of update which may be downloaded includes an update to the status of a set of credentials. An update may also be requested by the network access support system 26, for example to check the current status of a set of credentials (e.g. a value of credits remaining) or to delete a set of credentials where an account is withdrawn or suspended.

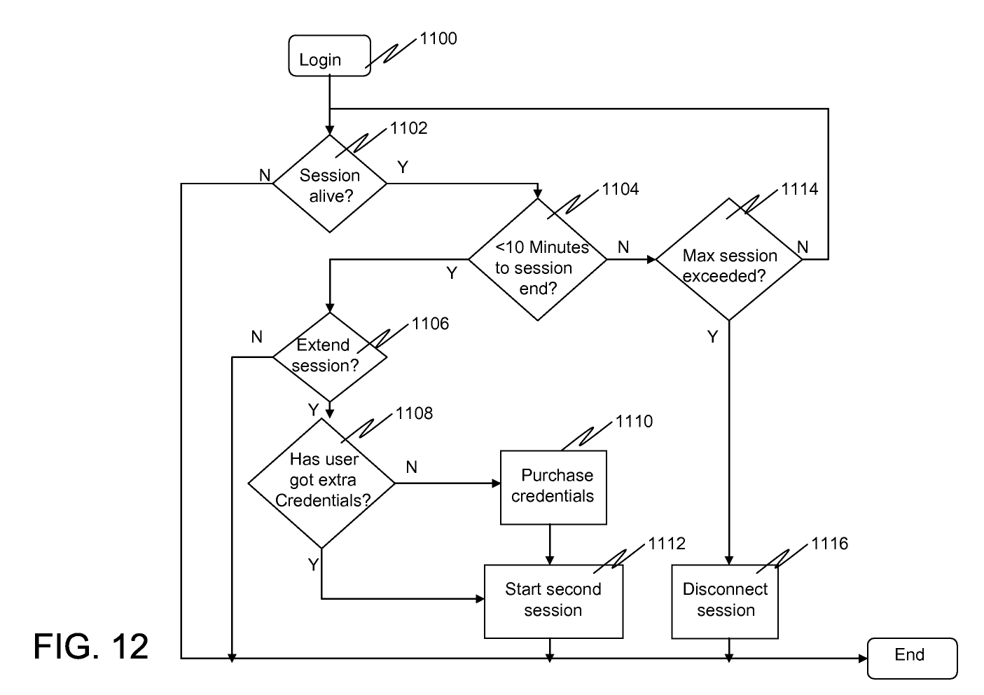

FIG. 12 illustrates a procedure carried out by the network access application 16 whilst the user is on-line, whereby the usage of credentials during an on-line access session is actively managed by the network access application. During an on-line session, starting at login 1100, the network access application checks whether the session is alive 1102 and if not alive, the procedure ends. If the session remains alive, the application checks whether the validity period of the set of credentials currently being used is nearing an end. This assumes that the user is currently using a set of limited validity credentials in the form of set of credentials which grant a user a certain period of on-line access (for example a one hour period). If the end of the on-line access period is nearing an end, the application detects this in 1104 and offers the user the option to extend the session further 1106, before the on-line session is ended. In this way, the user can activate a further set of credentials before the current set of credentials runs out, thereby enabling the session to be continued without difficulties. Difficulties may in particular be found where the user does not have a further set of credentials which may be used to access the current site, in which case there is a chance the user may no longer be able to login after the current access session has ended.

If the user wishes to extend the session in step 1106, the application 16 checks whether the user has extra credentials which match the site, 118, and if not, offers the user the option to buy access in step 1110. Since the user is currently on-line, the credentials which are offered may not necessary only be credentials stored in the encrypted credentials store 24, but further credentials from the credentials database 38 may also be offered, since the user currently has on-line access and therefore can contact network access support system 26 via the network 2. If the user does buy access in step 1110, or has extra credentials available in any case, the application 16 then starts the second session 1112. This session may be started either before or immediately after the first session has ended. A further element of session control is provided by network access application 16 in that a maximum session time may be enforced. This is enforced using a check 1114. A user may for example have a certain credit limit with a particular subscription type for which credentials are held. In this case, the network access application can enforce a maximum session, or some time, or some other limit to the usage of the credentials, in step 1114, and if the limit is exceeded, the session can be disconnected in step 1116. If neither of the checks 1104, 1114 are satisfied, then the procedure returns to step 1102 to continue the loop whilst the session is alive.

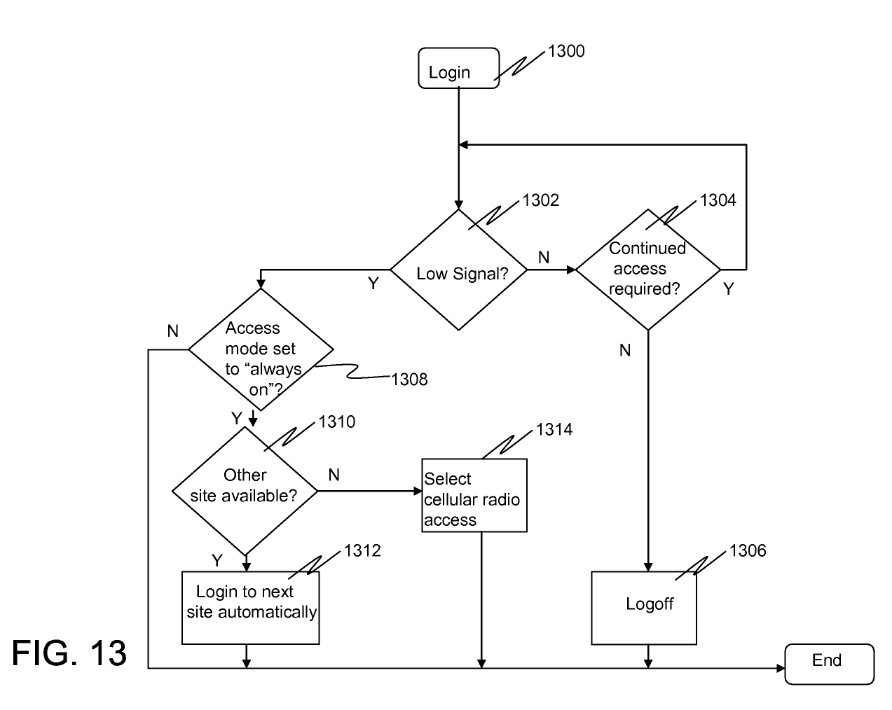

FIG. 13 illustrates a further procedure carried out by the network access application 16 whilst the user is on-line, whereby the maintenance of signal coverage during an on-line access session is actively managed by the network access application 16. During an on-line session, starting at login 1300, the network access application checks whether the signal strength on the current wireless hotspot access point is above a predetermined threshold, step 1302, and if so checks whether there is a need for continued network access, for example if there is a user application currently requiring network connectivity, step 1304. If not, the network access application 16 logs off, step 1306, and the procedure ends.

If a low signal strength is detected in step 1302, the application detects this in 1304 and checks whether the access mode is currently set to “always on”, step 1308. If not, the procedure ends and the network access is allowed in due course to be lost due to lack of signal—the user can then be prompted using the procedures described above in relation to FIGS. 6 to 10 whether a login to gain access to another site is to be conducted.

If in step 1308 it is detected that the access mode is currently set to “always on”, the access can be changed over to access via a different wireless hotspot access point before the coverage is lost. In this way, the user can gain access via a different wireless hotspot access point before the access via the first wireless hotspot access point is lost, thereby enabling the session to be continued without difficulties.

A search procedure, described in relation to FIG. 14 below, is then conducted in step 1310 to determine whether another site is available, i.e. whether there is signal coverage from another site and whether the user has authorization to access the site.

If another site is available, the application 16 conducts automatic login as described below to gain access. Note that there is no need for user intervention in the process between login via one wireless hotspot access point and the automatic login via another wireless hotspot access point and the automatic login, even if multiple sites are found on the radio interface and if multiple matches of those sites with user credentials are found.

If no alternative site is currently available, the network access application 16 may select network access via the cellular radio interface, step 1314, if the terminal has such a capability.

FIG. 14 illustrates procedures carried out by the network access application 16 when “always on” access mode is selected to search for an available site, i.e. wireless hotspot access point having coverage in the area of the terminal 10. In this type of search, the network access application 16 uses a “sniffer” application in the terminal 10 to find all wireless hotspot access points for which a signal is currently available, step 1200. If no site is found, step 1202, the search returns a “no site available” result, 1204.

If at least one site is found, step 1202, the network access application 16 detects from the signals received from each wireless hotspot access point the SSID of the operator, and presents each of the found sites in a search result set which is to be matched to the current set of credentials stored by in the user credentials wallet 20. Note that none of these search results rely on data stored within the directory store 18, other than the service provider table 18A which links the SSID to the name of the operator.

The network access application 16 attempts to match the site(s) to valid credentials stored in the user credentials wallet 20, step 1206. The network access application 16 attempts to match the site service information to the credentials stored in the user credentials wallet 20. Namely, the network access application 16 searches the user credentials wallet for credentials having a SSID which matches either the SSID of the service provider roaming site, or the SSID of each of the roaming partners of the service provider owning the site, as determined from service provider table 18A and service provider roaming table 18B.

If any sites are found, the user has access to the site due to an appropriate set of credentials being stored in the credentials wallet 20.

If a single match is found, step 1208, the network access application 16 proceeds to present the identified and selected site details to enable automatic login, using procedures described below, to the site, step 1210. Note that there is no need for user intervention in the process between the start of the procedure and the identification step 1210, even if multiple sites are found on the radio interface.

If multiple matches are found in step 1212, a particular site and set of credentials to use are selected before the automatic login. Selection between credentials, step 1216, is conducted automatically with reference to the “always on” mode preference settings set by the user, step 1214. Namely, the network access application 16 may conduct a comparison between the characteristics of the sites and/or the credentials and the “always on” mode preferences set by the user, as described above, to perform selection based on a comparison with either one or a combination of the following settings:

a) select lowest cost

b) select highest signal strength

c) select hotspot access point capability where available (e.g. virtual private network (VPN) capability)

d) select cellular radio access if available signal strength is lower than a predetermined threshold

e) select highest speed backhaul

f) select a voice only hotspot access point There may be a number of providers at a location. Based on the type of session required (e.g. email (circa 10 minutes) or long browse (circa 45 minutes) the network access application cam select which service provides best ‘value for money’. For example, a session using a particular application requiring only a short connection time, such as an email download session, may be better value with one service provider postpaid minutes than buying a new 60 minute voucher from another service provider. However, if the user already holds the other service provider's voucher already then that will be determined to be best value. A table of time-based costs versus session types can be used to provide this information in the network access application for use by its cost comparison function.

Once the best match is found in step 1216, the network access application 16 proceeds to present the identified and selected site details to enable automatic login, using procedures described below, to the site, step 1210. Note that there is no need for user intervention in the process between the start of the procedure and the identification step 1210, even if multiple sites are found on the radio interface and if multiple matches of those sites with user credentials are found.

If in step 1212 no match is found, this indicates that the user does not currently have authorization to access the site. However, it is possible that an appropriate encoded set of credentials is stored in the encrypted credentials store 24. The application checks in steps 1218, 1220 whether the user credentials store 24 has an appropriate match. If no appropriate match is found, a “no site available” result is returned, step 1228.

If a match is found in step 1220 a “buy access” button is shown on a screen similar to the site display screen 800. If in step 1224 the user actuates the “buy access” button, the user is presented with a cost and other details for the credentials offered, and it is determined whether the user wishes to purchase the credentials stored in the encrypted credentials store 24. If the user does not wish to purchase, a “no site available” result is returned, step 1228, and the procedure ends. If the user does wish to purchase the credentials in step 546, a “remote purchase” process is carried out, step 1226, whereby the network access application 16 decrypts the appropriate set of encrypted credentials, and transfers the credentials to the user credentials wallet 20. At the same time, a sales record is generated by the network access application 16 which is stored in the service usage store 22. The sales record is then subsequently transferred back to the network access provider system 26 once the user is on-line, during an update procedure as described in further detail below. Once purchased, the appropriate credentials are indeed held by the user in the user credentials wallet 20, and the network access application 16 proceeds to present the identified and selected site details to enable automatic login, using procedures described below, step 1210.

Note that there is need for only one instance of user intervention in the process between the start of the procedure and the identification step, even if multiple sites are found on the radio interface and if multiple matches of those sites with user credentials are found, and even though no current credentials were held other than in the encrypted credentials store 24.

An alternative embodiment is envisaged where no user intervention is necessary—in which step 1226 follows automatically from step 1220 if a match is found, however it is generally preferred that the user is given the option to accept or decline the purchase of new credentials.

In order to conduct a login procedure according to any of the methods described above in relation to FIG. 6 to 14, the network access application 16 has two alternative methods of logging in. Firstly, if the site is enabled with a wireless hotspot access point authentication protocol, as mentioned above, the network access application uses the appropriate wireless hotspot access point authentication protocol in order to transmit the appropriate credentials to the site, and thereby to login. Otherwise, the site will most likely have a web page which includes certain form fields which are designed to be filled in manually by a user. Namely, the user is generally required to enter their user name in a “user name” field and their password in a “password” field. In this embodiment, the network access application is able to enter such details on a web page automatically. In a simplified embodiment, the network access application launches a web browser application, which then navigates to the login web page. The network access application 16 then enters the credentials selected, automatically, into the first two form fields in the web page, and transmits the form back to the site. In this way, automatic logging in is conducted. More sophisticated procedures can be used, particularly, since some service providers use different word page formats. By storing a logging in procedure which is different for different service providers, and are using a different such procedure depending on the identified owner of the site, which is identified using the SSID of the site as either retrieved from the directory store 18 or “sniffed” from the signals received, an appropriate automated login procedure can be used which will have greater success rate then the simplified login procedure referred to above.

Yet further details of features and alternatives to the embodiments described above are envisaged, as follows.
Where a user uses vouchers supplied by the network access support system, a post-pay bill can be produced at the end of the month for all vouchers consumed, and the bill is settled typically from a credit card or direct debit
Access can be many forms—
   minutes billed postpaid
   vouchers/minutes we have prepaid to the carrier
   vouchers paid on activation.
   a top up value store which is decremented

The above embodiments are to be understood as illustrative examples of the invention. Further embodiments of the invention are envisaged.

The credentials provider system need not be a network access support system. The credentials management function may be carried out without the directory function.

Whilst in the above-described embodiment the “always on” access mode and the “ask before connect” access mode are user-selected settings which are set manually, they may alternatively be set based upon a related setting. For example, a particular setting may be related to a current profile. The profiles could for example be a corporate user profile, with which the “always on” mode could be associated, and the “ask before connect” mode could be associated with a home user profile. The modes may also be automatically switched based on current time of day or other factors, such as the type of user application currently in use.

The wireless hotspot access points need not only be Wi-Fi or WiMax hotspot access points. They may implement other protocols.

The credentials may be compatible with Radius and AAA systems, subscription accounts, single and multiple use ‘e-vouchers’, ‘Pay as you Go’ top up accounts and Voice and Data PINs. The credentials may take a form other than a username and password, such as a subscriber identifier and authenticator.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of providing a user with access to a communications system via a plurality of wireless hotspot access points, said method comprising providing a set of functions for use on a user terminal, said functions including functions for:
storing a plurality of sets of user identification data, said user identification data relating to one or more wireless hotspot access points via which the user has authorization to access the communications system;
using a first set of said plurality of sets of user identification data to access the communications system via a first wireless hotspot access point; and
without user intervention, altering access to said communications system from being via said first hotspot access point to being via a second wireless hotspot access point, by:
identifying said second wireless hotspot access point; and
selecting, on the basis of said identification, a second set of user identification data, different to said first set of identification data, and
using said second set of user identification data to access the communication system via said second wireless hotspot access point.

2. A method according to claim 1, wherein the user identification data include, for a wireless hotspot access point via which the user has authorization to access the communications system, user credentials for use in authenticating the user with an identified wireless hotspot access point.

3. A method according to claim 2, wherein the user identification data includes a plurality of sets of user credentials, each said set being in the form of a username and password combination.

4. A method according to claim 2, wherein the said functions include functions for transmitting user credentials to an identified wireless hotspot access point.

5. A method according to claim 4, wherein the said functions include functions for, if an identified wireless hotspot access point is enabled with a wireless login protocol, transmitting user credentials using said wireless login protocol.

6. A method according to claim 4, wherein the said functions include functions for, if an identified wireless hotspot access point provides a login web page, identifying one or more form fields in said login web page, and automatically filling in said one or more form fields with user credentials.

7. A method according to claim 6, wherein the said functions include functions for storing data defining a plurality of different login procedures and selecting between said different login procedures in dependence on data received from a wireless hotspot access point.

8. A method according to claim 1, comprising receiving wireless hotspot access point identification data and using said one set of user identification data in combination with said wireless hotspot access point identification data to determine whether the user has authorization to access the communications system via an identified wireless hotspot access point.

9. A method according to claim 1, wherein said functions comprise functions for:
requesting user input before altering access to said communications system from being via said first hotspot access point to being via a second wireless hotspot access point, by:
identifying said second wireless hotspot access point; and
on the basis of said identification, requesting user input before proceeding to access the communication system via said second wireless hotspot access point.

10. A method according to claim 9, comprising conducting network access via a cellular communications system in response to not receiving user input confirming a user's decision to proceed to access the communication system via said second wireless hotspot access point.

11. A method according to claim 1, wherein said functions include a function for selecting access settings, said access settings including settings for determining whether altering access to said communications system from being via said first hotspot access point to being via a second wireless hotspot access point is conducted either:
a) without user intervention; or
b) after receiving user input confirming a user's decision to proceed.

12. A method according to claim 1, said functions comprising functions for:
storing user credentials in a user terminal, said user credentials being for authorizing the user to access the communications system via one or more wireless hotspot access points, wherein the stored user credentials include:
i) first user credentials which are held in a first state, and in said first state, the user can use the credentials to access the communications system via an identified wireless hotspot access point; and
ii) second user credentials which are held in a second state, and in said second state, the user cannot use the credentials to access the communications system via an identified wireless hotspot access point; and
conducting a procedure whereby said second user credentials are converted to said first state.

13. A method according to claim 1, said functions comprising functions for:
storing limited validity user credentials in a user terminal, said limited validity user credentials being for authorizing the user to access the communications system via one or more wireless hotspot access points, wherein the limited validity user credentials have a predetermined temporal usage limit associated therewith in said communications system; and
monitoring usage of the limited validity user credentials, and in response thereto conducting a transfer of further limited validity user credentials between the user terminal and a remote data processing system before said temporal usage limit expires.

14. A method according to claim 1, said functions comprising functions for:
storing service provider identity data associated with said plurality of sets of user credentials;
using said service provider data to identify a set of credentials suitable for use with an identified wireless hotspot access point;
storing preference data associated with said sets of user credentials; and
where a plurality of different sets of credentials are suitable for use in gaining network access, using said preference data to select between said plurality of sets of user credentials.

15. A method according to claim 1, said functions comprising functions for:
accessing a directory of wireless hotspot access points in said communications system, said directory including wireless hotspot access point identification data;
using said directory to identify said second wireless hotspot access point.

16. A method according to claim 15, wherein said directory includes service provider identification data and wherein different ones of said plurality of sets of user identification data are associated with different service providers.

17. A method according to claim 15, wherein said directory is stored on the user terminal.

18. A method according to claim 15, wherein said directory includes data identifying individual wireless access points.

19. A method of providing a user with access to a communications system via a plurality of wireless hotspot access points, said method comprising providing a set of functions for use on a user terminal, said functions including functions for:
using first user identification data to access the communications system via a first wireless hotspot access point; and
altering access to said communications system from being via said first hotspot access point to being via a second wireless hotspot access point, by:
identifying said second wireless hotspot access point; and
in response to said identification, using second user identification data, different to said first user identification data, to access the communication system via said second wireless hotspot access point;
selecting access settings, said access settings including settings for determining whether altering access to said communications system from being via said first hotspot access point to being via a second wireless hotspot access point is conducted either:
a) without user intervention; or
b) after receiving user input confirming a user's decision to proceed.

20. A computer-readable storage medium storing program code for causing a computer to perform the steps of:
storing a plurality of sets of user identification data, said user identification data relating to one or more wireless hotspot access points via which the user has authorization to access the communications system;
using a first set of said plurality of sets of user identification data to access the communications system via a first wireless hotspot access point; and
without user intervention, altering access to said communications system from being via said first hotspot access point to being via a second wireless hotspot access point, by:
identifying said second wireless hotspot access point; and
selecting, on the basis of said identification, a second set of user identification data, different to said first set of identification data, and
using said second set of user identification data to access the communication system via said second wireless hotspot access point.
